(19) United States
(12) Patent Application Publication
(10) Pub. No.: US 2026/0155318 A1
(43) Pub. Date: Jun. 4, 2026

(54) TEST SWITCH

(71) Applicants: HUBERT Ostmeier, Alexandria, VA (US); Emmanuel Ostmeier, Alexandria, VA (US)

(72) Inventors: HUBERT Ostmeier, Alexandria, VA (US); Emmanuel Ostmeier, Alexandria, VA (US)

(21) Appl. No.: 18/964,368

(22) Filed: Nov. 30, 2024

(51) Int. Cl. H01H 1/42; H01H 1/26; H01H 73/04

(52) U.S. Cl. CPC H01H 1/42; H01H 1/26; H01H 73/04

(57) ABSTRACT

A test switch, including a base having a height axis, a length axis, and a width, a pair of side biased contacts that move apart when a blade is inserted between the pair of side biased contacts, and a spring in a spring holder in contact where the spring is in contact with one of the pair of side biased contacts. Each of the contacts is conductively connected to a conductor, the spring is at an angle θ degrees to the height axis where θ is between 14° and 18°, the base width is approximately 1 13/16 inches, and the test switch is rated for at least 600 volts and 30 amps. Furthermore, θ may be between 15°and 17°or preferably θ is approximately 16°. Finally, the test switch meets or exceeds the requirements of ANSI/IEEE Standard C37.90.

### FIELD OF INVENTION

The present invention relates generally to test switches to isolate and service installed equipment. These test switches include a fixed connection block connected to the installed equipment, and may utilize a make-before-break current short circuit feature. These test switches are used in medium to high voltage power systems and must meet certain standardized requirements (e.g., ANSI/IEEE Standard C37.90).

### BACKGROUND OF THE INVENTION

The prior art test switches for installed equipment in medium to high voltage power systems have proven to be complex and difficult in providing a secure interaction with the installed equipment given the size limitations of such test switches imposed by standardization. The prior art test switches fail to provide a sufficiently long-time stable connection with the installed equipment and have been prone to accidents. Accordingly, there is a strong need in the test switch art to provide an improved test switch or test plug that meets the standardization requirements of such test switches while providing a safe, simple, fast and reliable way to isolate and service installed equipment.

### BRIEF SUMMARY OF THE INVENTION

Objects of the invention may be provided by a test switch, including a base having a height axis, a length axis, and a width axis where the height axis, the length axis, and the width axis are all normal to each other, a pair of side biased contacts that move apart when a blade is inserted along the height axis between the pair of side biased contacts, and a spring in a spring holder in contact where the spring is in contact with one of the pair of side biased contacts. Each of the contacts is conductively connected to a conductor. The spring is at an angle θ degrees to the height axis, where θ is between 14 and 18 degrees. The base width is approximately 1 13/16 inches. A top portion on a top of the base has a top width W_{T} greater than the base width, and the test switch is rated for at least 600 volts and 30 amps. The top width W_{T} may be approximately 2 inches or less. The test switch may have a θ between 15 and 17 degrees, and may preferably be approximately 16 degrees. Advantageously the test switch meets or exceeds the requirements of ANSI/IEEE Standard C37.90. The blade may include a conductive material on a side of the blade not adjacent the spring and the conductive material may be metal.

### BRIEF DESCRIPTION OF THE DRAWINGS

The invention is now described in more detail based on an advantageous embodiment with reference to drawing figures, wherein:

FIG. 1 illustrates a test switch of the invention without a pin;

FIG. 2 illustrates a pin to be inserted into the test switch of FIG. 1;

FIG. 3 illustrates the pin inserted between the side biased contacts of the test switch;

FIG. 4 illustrates the pin inserted into the storage position in the test switch;

FIG. 5 illustrates spring in FIG. 1 in greater detail; and

FIG. 6 illustrates spring in FIG. 3 in greater detail.

### DETAILED DESCRIPTION OF THE INVENTION

The test switches of the invention are a smart solution for isolating and servicing equipment in medium to high voltage power systems. For example, the test switches of the invention are typically rated at 600 volts and 30 amps or more while meeting or exceeding the requirements of ANSI/IEEE Standard C37.90.

The test switches of the invention are designed for semi-flush mounting on the front of switchboard panels to facilitate inspection and accessibility. The base of the test switches of the invention are made of electrical grade plastic material (often black in color), which provides a tough and insulated enclosure. Barriers are molded into the base (front and rear) to separate the test switches of the invention from each other. The barriers also provide insulation between poles while providing ample space between terminals.

The test switches of the invention include a cover (typically an opaque black cover or a clear see through cover) that provides a tough insulated enclosure for the test switches of the invention which is also made of plastic. Clear covers allow for leaving handles of the test switches of the invention in the open position and replacing the cover while maintaining a meter type seal which some or all handles are in the open position. This allows the user to service the installed electrical equipment while complying with OSHA lockout/tagout procedures. Clear covers may be retrofitted to existing switches.

The switch handles may be made of a molded plastic insulating material of any desired color (e.g., red or black) or may be made from any other suitable insulating material. Each switch handle may include a dovetail indentation to hold a circuit identification label.

The test switches may be configured to have a single test switch or test plug, or may be configured to have multiple test switches (e.g., 2 to 10). Each pole may be separately identified with a letter, number or other identifier (e.g., A through J). The test switches may provide potential poles or current poles.

The test switches are operated with knife blades that do the make-before-break current short function. These knife blades may be single knife blades or may be plural knife blades ganged together with an interlocking bar to suit testing needs. A hole may be provided in each switch handle to allow the insertion of interlocking bar so that the test switches may be mechanically tied together.

The test switches of the invention may be located at the rear of the test switches and may be either screw or stud type. The terminals are preferably labeled (e.g., 1 to 20) for easy identification.

Test plugs are typically used to connect devices measuring current and voltages being applied to relays, meters and instruments without interrupting or short-circuiting the circuit. Only the current test switches with the current jack must be opened before inserting the test plug. Connections to the test plug must be made before inserting the test plug into the test switch.

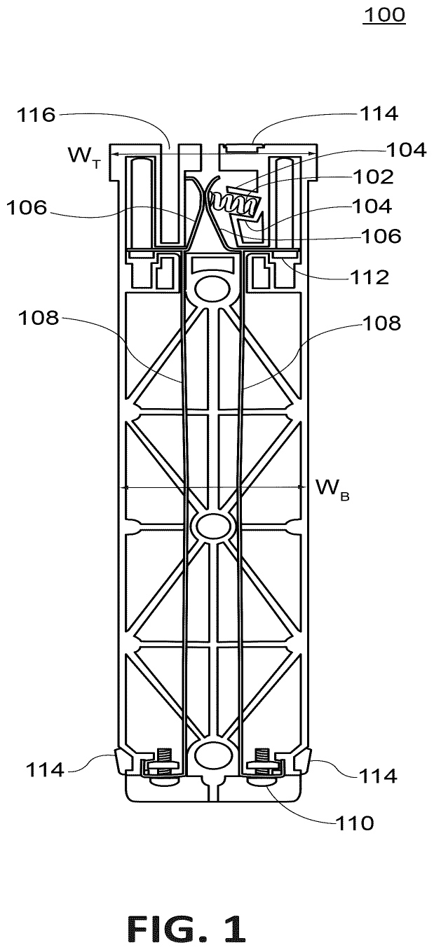

FIG. 1 illustrates a test switch 100 of the invention without a pin 200. The test switch 100 has a body having a spring 102 in a spring holder position 104. The spring 102 presses again one of two side biased contacts 106 while the other of the two side bias contacts 106 is simply bounded by the body of the test switch 100. The two side bias contacts 106 each are conductively connected to a conductor 108 which conductively connects to a screw and nut 110 near the bottom of the test switch 100 and a nut attached to a screw-in test contact 112 near the top of the test switch 100. The screw and nut 110 may be connected with installed equipment. The side walls of the spring holder position 104 are at an angle of θ degrees to normal plane of the height axis of the test switch 100. This angles the spring 102 at the same θ degrees to normal plane of the height axis of the test switch 100. θ may be from 14 to 18, or preferably 15 to 17. In the figures, θ is 16. For test switches having a base width of approximately 1 13/16 inches and rated for at least 600 volts and 30 amps, when θ was 0 to less than 14 degrees the spring 102 is either completely compressed such that it does not functioning correctly or is too small a spring and fails to hold an insert blade 202 of a pin 200 in place. Since the convention side biased contacts use the spring at θ=0 degrees, conventional configurations are not usable. For test switches having a base width of approximately 1 13/16 inches and rated for at least 600 volts and 30 amps, when θ was greater than 18 degrees, the spring 102 is so off axis that insufficient force is applied to the blade 202 and fails to hold an inserted blade 202 of a pin 200 in place. It is also noted that test devices for the invention are required to have a base width W_{B} of approximately 1 13/16 inches and rated for at least 600 volts and 30 amps. Trying to scale devices of other sizes does not work. Similarly, trying to improve the rating to that required of the inventive test switch also results in devices that do not work properly.

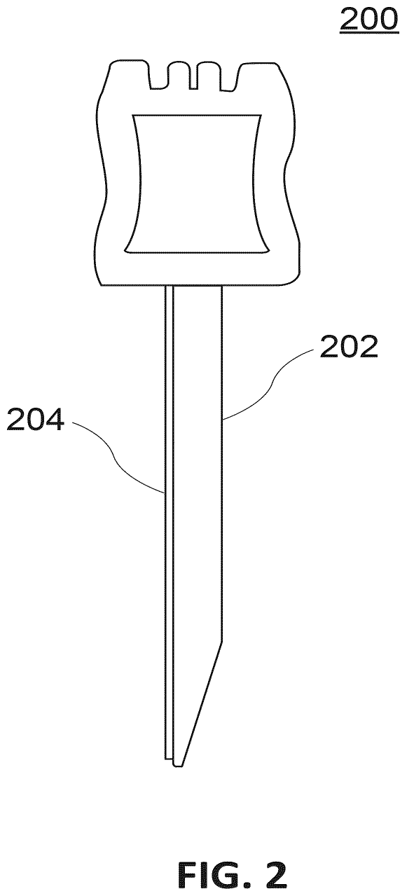

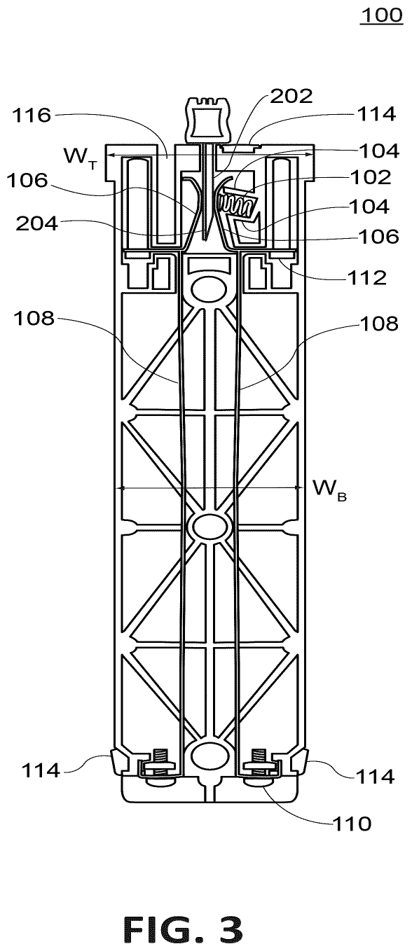

FIG. 2 illustrates a pin 200 to be inserted into the test switch 100 of FIG. 1. The pin 200 includes a blade 202 which is used to separate the two side bias contacts 106 from each other. The pin 200 may be coded (e.g., shaped) such that it can only be inserted into the test switch 100 in one direction. For example, the pin 200 may have coding so that metal part 204 of the blade 202 is not facing towards the spring 102 (e.g., facing towards the left side of FIG. 3.) and the tip bevel always face towards the spring 102 (e.g., facing towards the right side of FIG. 3.) By having the metal part 204 not facing the spring 102, the make-before-break current short function is ensured even if the blade is inserted at a non-vertical angle initially. Alternatively, the metal part 202 could be made of any conductive material.

FIG. 3 illustrates the pin 200 inserted between the side biased contacts 106 of the test switch 100. As can be seen in this figure, the side biased contacts 106 are no longer touching each other and the spring 102 is almost entirely compressed. A timing sequence for identical length pins 200 may be varied by having differing elevations of electrical contacts in the test switch 100 to assure that signal circuit are opened before transformer circuits are opened.

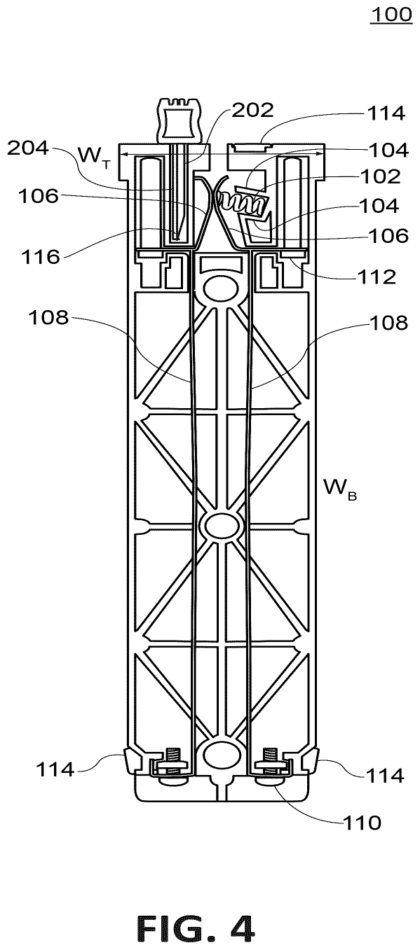

FIG. 4 illustrates the pin 200 inserted into the storage position 116 in the test switch 100. The two side bias contacts 106 are in contact with each other just like in FIG. 1. In fact, FIG. 4 is identical to FIG. 1 except that the pin 200 is in the storage position 116. The pin 200 changing nothing about the test switch 100 in an electrical sense.

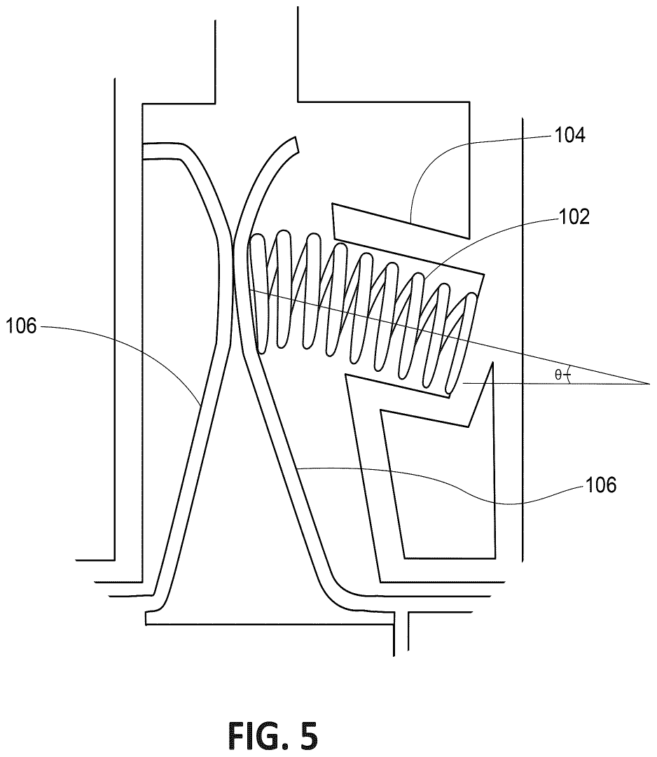

FIG. 5 illustrates spring in FIG. 1 in greater detail. The key point is the spring 102 is still compressible and the off axis angle θ of the spring 102 is illustrated.

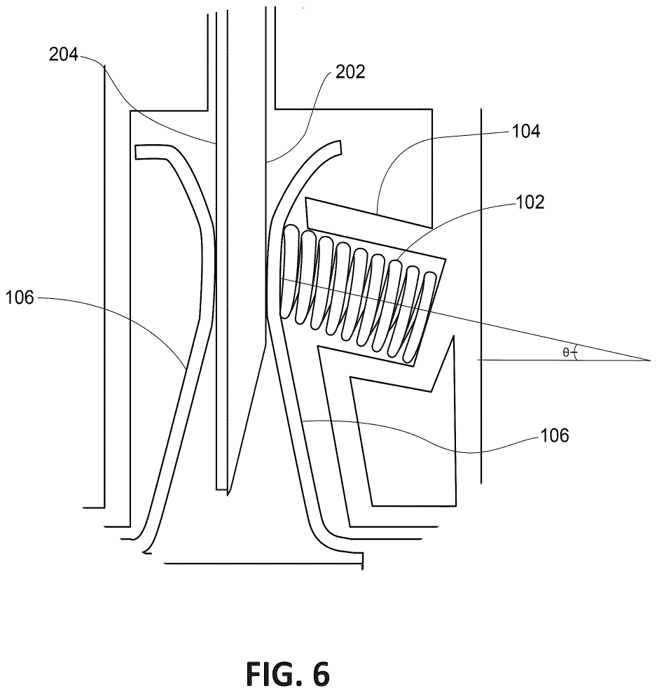

FIG. 6 illustrates spring in FIG. 3 in greater detail. The key point is the spring 102 is fully or nearly fully compressed and the off axis angle θ of the spring 102 is illustrated.

As used herein and in the claims, approximately means within the normal variation of the manufacturing process and that results in usable components. Thus, the variation is typically minimal.

The test switches 100 are rated at 600 volts and 30 amps while meeting or exceeding the requirements of ANSI/IEEE Standard C37.90.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

### REFERENCE NUMERALS AND DESIGNATIONS

100 Test switch
102 Spring
104 Spring holder portion
106 Side biased contact
108 Conductor
110 Screw and nut
112 Nut attached to a screw-in test contact
114 Labeling
116 Storage position
200 Pin
202 Blade portion of the pin
204 metal part of the blade 202
θ Off axis angle of the spring
W_{B} Width of the body of the test switch 100
W_{T} Width of the top of the test switch 100

What is claimed is:

1. A test switch, comprising:
a base having a height axis, a length axis, and a width axis where the height axis, the length axis, and the width axis are all normal to each other;
a pair of side biased contacts that move apart when a blade is inserted along the height axis between the pair of side biased contacts; and
a spring in a spring holder in contact where the spring is in contact with one of the pair of side biased contacts;
wherein each of the contacts is conductively connected to a conductor,
wherein the spring is at an angle θ degrees to the height axis,
wherein θ is between 14 and 18 degrees,
wherein the base width is approximately 1 13/16 inches,
wherein a top portion on a top of the base having a top width greater than the base width, and
wherein the test switch is rated for at least 600 volts and 30 amps.

2. The test switch of claim 1, wherein the top width is approximately 2 inches or more.

3. The test switch of claim 1, wherein θ is between 15 and 17 degrees

4. The test switch of claim 1, wherein θ is approximately 16 degrees

5. The test switch of claim 1, wherein the test switch meets or exceeds the requirements of ANSI/IEEE Standard C37.90.

6. The test switch of claim 1, wherein the blade has a conductive material on a side of the blade not adjacent the spring.

7. The test switch of claim 1, wherein conductive material is metal.
